(19) United States
(12) Patent Application Publication
(10) Pub. No.: US 2015/0020000 A1
(43) Pub. Date: Jan. 15, 2015

(54) SYSTEM AND METHOD FOR CREATING A UNIQUE MEDIA AND INFORMATION MANAGEMENT PLATFORM

(71) Applicant: CRACKPOT INC., LAS VEGAS, NV (US)

(72) Inventor: Stephen White, Las Vegas, NV (US)

(21) Appl. No.: 14/178,475

(22) Filed: Feb. 12, 2014

Related U.S. Application Data
(60) Provisional application No. 61/930,448, filed on Jan. 22, 2014.
(60) Provisional application No. 61/903,180, filed on Nov. 12, 2013.
(60) Provisional application No. 61/845,005, filed on Jul. 11, 2013.

(51) Int. Cl. H04L 12/24

(52) U.S. Cl. CPC H04L 41/22
USPC 715/753

(57) ABSTRACT

The present invention provides a computer-implemented platform for creating a social network interface, comprising a non-transitory computer readable storage medium having encoded thereon non-transitory computer executable instructions which, when executed by at least one processor provides, on at least one computing network, a graphical user interface (GUI) for the computer-implemented platform that further provides access to a plurality of content comprising a plurality of content types, allows for selection of at least first ones of the content from the plurality of content for association with at least second ones of the content from the plurality of content, provides at least two of a time, type and location stamp in association with the plurality of content, provides at least one association between the at least first ones of the content and the at least second ones of the content in accordance with at least one rule; and provides display of the at least first ones of the content contemporaneously with at least second ones of the content from the plurality of content, wherein the at least first ones of the content and the at least second ones of the content are of a different content type.

### CROSS-REFERENCE TO RELATED APPLICATION

This application claims priority to U.S. Provisional Patent Application Ser. No. 61/930,448, filed Jan. 22, 2014, entitled “System and Methods for Delivery Information and a Platform for Same”, U.S. Provisional Patent Application Ser. No. 61/903,180, filed Nov. 12, 2013, entitled “Systems and Method for Mobile Social Network Interactions”, and U.S. Provisional Application Ser. No. 61/845,005, filed Jul. 11, 2013 entitled, “Engine, System and Method of Providing Interactive Content Delivery Management”, each of which are incorporated by reference herein as if set forth herein in their entireties.

The present application is also related to U.S. patent application Ser. No. ______ , entitled “Computer-Implemented Virtual Object for Managing Digital Content”, U.S. patent application Ser. No. ______ entitled “System and Method for Creating a Unique Media and Information Management Platform”, and U.S. patent application Ser. No. ______ entitled “An Apparatus, System and Method for a Graphical User Interface for a Multi-Dimensional Networked Content Platform”, which are all filed contemporaneously, the entireties of which are incorporated by reference herein.

### BACKGROUND

1. Field of the Invention

The present invention relates aspects of social media and interaction, and, more particularly, to an engine, system and method of providing cloud-based communication services.

2. Background of the Invention

In the present environment, one's virtual presence is synonymous with an actual, physical presence. That is, a large portion of who a person is—the person's interests, likes, beliefs, and the like—may be presented to the world via social media.

However, currently available platforms suitable to provide content of interest, and accordingly suitable to show the world one's interests, beliefs, etc., operate independently of one another. That is, a professional face, and hence professionally-related content, may be presented to the world via LinkedIn, and an artistic face, that is, artistic content, may be presented to the world via Instagram.

As such, the number of current communications platforms is overwhelming, and it is impossible to share multiple facets of a person using known methods. For example, a student athlete's have taken to developing their own unique websites to try to attract colleges, in part because there is no single platform presently available for the student athlete to share game videos, express herself, share her scholarly pursuits, likes, interests, hobbies, social/virtual presence, and more with a prospective college recruiting for such an athlete.

Moreover, known means of content provision do not scale well, in large measure because such means provide only two-dimensional methodologies for providing content. Accordingly, in typical known embodiments, a viewer of content provided by a user must scroll, flip, or otherwise maneuver as between content provision screens or the like. This is exceedingly inconvenient, particularly in a mobile environment having limited screen size.

There is thus no currently available platform that is suitable to provide various types and substantially unlimited amounts of content, including audio, image, video, text, site, RSS feed, social media, e-magazine, and e-commerce, integration in an interactive, digital interface. Further, it would be preferable that such a platform provide a three dimensional content-providing platform, to thereby improve the efficiency of providing the content. Additionally, a graphical user interface to allow for the creation of the aspects associated with such a platform would be advantageous.

Thus, the need exists for an apparatus, system and method for a graphical user interface for a multi-dimensional networked content platform.

### SUMMARY

The present invention provides a system and method for visually aiding communications by at least one user providing a plurality of content types which may be associated with each other to form unified portions of information having disparate content types. The system and method may include a non-transitory computer readable storage medium having encoded thereon non-transitory computer executable instructions which, when executed by at least one processor, provide, on at least one computing network, a graphical user interface (GUI) for the computer-implemented platform that: provides access to a plurality of content comprising a plurality of content types; allows for the providing of a plurality of content having a type and time stamp in association with the content; and allows for selection of access rules for third parties attempting to access the selected content.

Thus, the present invention provides an apparatus, system and method for a graphical user interface for a multi-dimensional networked content platform.

### BRIEF DESCRIPTION OF THE DRAWINGS

The accompanying drawings are included to provide a further understanding of the disclosed embodiments. In the drawings, like numerals represent like elements, and:

FIG. 1 illustrates an aspect of an exemplary embodiment of the present invention;

FIG. 2 illustrates an aspect of an exemplary embodiment of the present invention;

FIG. 3 illustrates an aspect of an exemplary embodiment of the present invention;

FIG. 4 illustrates an aspect of an exemplary embodiment of the present invention;

FIG. 5 illustrates an aspect of an exemplary embodiment of the present invention;

FIG. 6 illustrates an aspect of an exemplary embodiment of the present invention;

FIG. 7 illustrates an aspect of an exemplary embodiment of the present invention; and

FIG. 8 illustrates an aspect of an exemplary embodiment of the present invention.

### DETAILED DESCRIPTION

Computer-implemented platforms, engines, systems and methods of use are disclosed that provide networked access to a plurality of types of digital content, including but not limited to video, audio, metadata, interactive and document content, and that track, deliver manipulate, transform and report the accessed content. Described embodiments of these platforms, engines, systems and methods are intended to be exemplary and not limiting. As such, it is contemplated that the herein described systems and methods can be adapted to provide many types of cloud-based valuations, scoring, marketplaces, and the like, and can be extended to provide enhancements and/or additions to the exemplary platforms, engines, systems and methods described. The invention is thus intended to include all such extensions. Reference will now be made in detail to various exemplary and illustrative embodiments of the present invention.

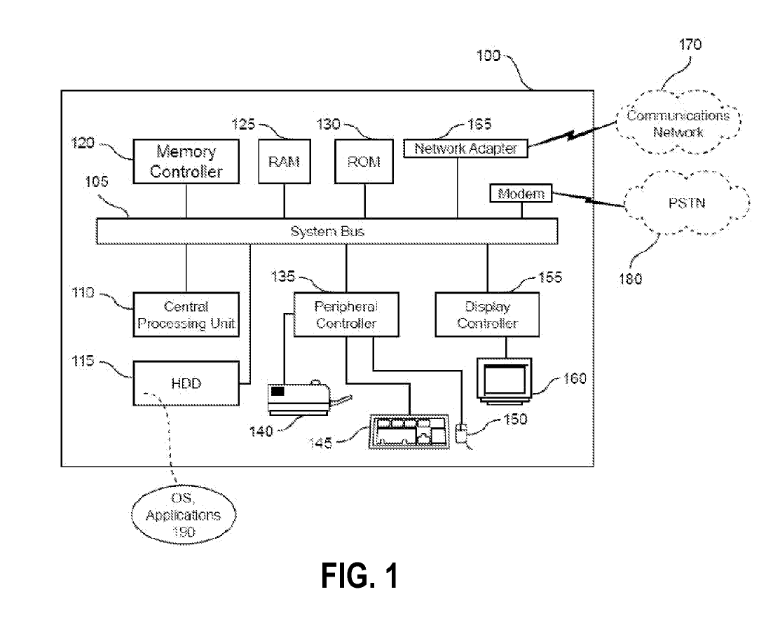

FIG. 1 depicts an exemplary computing system 100 for use in accordance with herein described system and methods. Computing system 100 is capable of executing software, such as an operating system (OS) and a variety of computing applications 190. The operation of exemplary computing system 100 is controlled primarily by computer readable instructions, such as instructions stored in a computer readable storage medium, such as hard disk drive (HDD) 115, optical disk (not shown) such as a CD or DVD, solid state drive (not shown) such as a USB “thumb drive,” or the like. Such instructions may be executed within central processing unit (CPU) 110 to cause computing system 100 to perform operations. In many known computer servers, workstations, personal computers, and the like, CPU 110 is implemented in an integrated circuit called a processor.

It is appreciated that, although exemplary computing system 100 is shown to comprise a single CPU 110, such description is merely illustrative as computing system 100 may comprise a plurality of CPUs 110. Additionally, computing system 100 may exploit the resources of remote CPUs (not shown), for example, through communications network 170 or some other data communications means.

In operation, CPU 110 fetches, decodes, and executes instructions from a computer readable storage medium such as HDD 115. Such instructions can be included in software such as an operating system (OS), executable programs, and the like. Information, such as computer instructions and other computer readable data, is transferred between components of computing system 100 via the system's main data-transfer path. The main data-transfer path may use a system bus architecture 105, although other computer architectures (not shown) can be used, such as architectures using serializers and deserializers and crossbar switches to communicate data between devices over serial communication paths. System bus 105 can include data lines for sending data, address lines for sending addresses, and control lines for sending interrupts and for operating the system bus. Some busses provide bus arbitration that regulates access to the bus by extension cards, controllers, and CPU 110. Devices that attach to the busses and arbitrate access to the bus are called bus masters. Bus master support also allows multiprocessor configurations of the busses to be created by the addition of bus master adapters containing processors and support chips.

Memory devices coupled to system bus 105 can include random access memory (RAM) 125 and read only memory (ROM) 130. Such memories include circuitry that allows information to be stored and retrieved. ROMs 130 generally contain stored data that cannot be modified. Data stored in RAM 125 can be read or changed by CPU 110 or other hardware devices. Access to RAM 125 and/or ROM 130 may be controlled by memory controller 120. Memory controller 120 may provide an address translation function that translates virtual addresses into physical addresses as instructions are executed. Memory controller 120 may also provide a memory protection function that isolates processes within the system and isolates system processes from user processes. Thus, a program running in user mode can normally access only memory mapped by its own process virtual address space; it cannot access memory within another process' virtual address space unless memory sharing between the processes has been set up.

In addition, computing system 100 may contain peripheral controller 135 responsible for communicating instructions using a peripheral bus from CPU 110 to peripherals, such as printer 140, keyboard 145, and mouse 150. An example of a peripheral bus is the Peripheral Component Interconnect (PCI) bus.

Display 160, which is controlled by display controller 155, can be used to display visual output and/or presentation generated by or at the request of computing system 100. Such visual output may include text, graphics, animated graphics, and/or video, for example. Display 160 may be implemented with a CRT-based video display, an LCD-based flat-panel display, gas plasma-based flat-panel display, touch-panel, or the like. Display controller 155 includes electronic components required to generate a video signal that is sent to display 160.

Further, computing system 100 may contain network adapter 165 which may be used to couple computing system 100 to an external communication network 170, which may include or provide access to the Internet. Communications network 170 may provide user access for computing system 100 with means of communicating and transferring software and information electronically. Additionally, communications network 170 may provide for distributed processing, which involves several computers and the sharing of workloads or cooperative efforts in performing a task. It is appreciated that the network connections shown are exemplary and other means of establishing communications links between computing system 100 and remote users may be used.

It is appreciated that exemplary computing system 100 is merely illustrative of a computing environment in which the herein described systems and methods may operate and does not limit the implementation of the herein described systems and methods in computing environments having differing components and configurations, as the inventive concepts described herein may be implemented in various computing environments using various components and configurations.

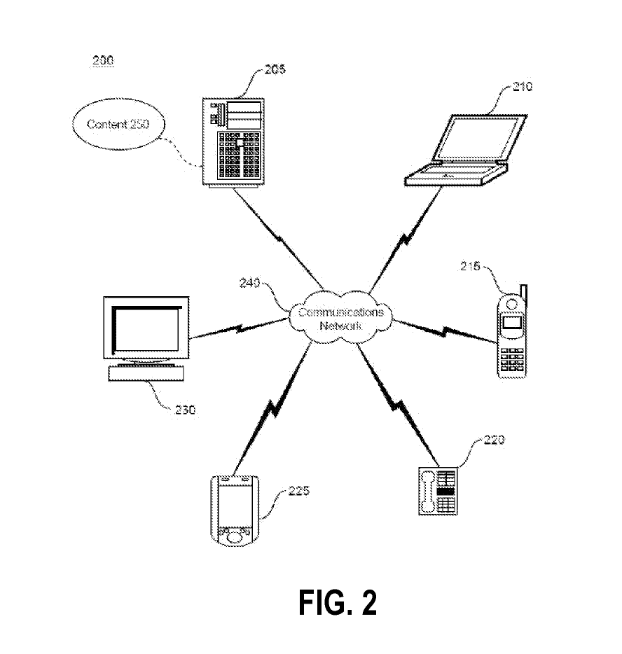

As shown in FIG. 2, computing system 100 can be deployed in networked computing environment 200. In general, the above description for computing system 100 applies to server, client, and peer computers deployed in a networked environment, for example, server 205, laptop computer 210, and desktop computer 230. FIG. 2 illustrates an exemplary illustrative networked computing environment 200, with a server in communication with client computing and/or communicating devices via a communications network, in which the herein described apparatus and methods may be employed.

As shown in FIG. 2, server 205 may be interconnected via a communications network 240 (which may include any of, or any combination of, a fixed-wire or wireless LAN, WAN, intranet, extranet, peer-to-peer network, virtual private network, the Internet, or other communications network such as POTS, ISDN, VoIP, PSTN, etc.) with a number of client computing/communication devices such as laptop computer 210, wireless mobile telephone 215, wired telephone 220, personal digital assistant 225, user desktop computer 230, and/or other communication enabled devices (not shown). Server 205 can comprise dedicated servers operable to process and communicate data such as digital content 250 to and from client devices 210, 215, 220, 225, 230, etc. using any of a number of known protocols, such as hypertext transfer protocol (HTTP), file transfer protocol (FTP), simple object access protocol (SOAP), wireless application protocol (WAP), or the like. Additionally, networked computing environment 200 can utilize various data security protocols such as secured socket layer (SSL), pretty good privacy (PGP), virtual private network (VPN) security, or the like. Each client device 210, 215, 220, 225, 230, etc. can be equipped with an operating system operable to support one or more computing and/or communication applications, such as a web browser (not shown), email (not shown), or the like, to interact with server 205.

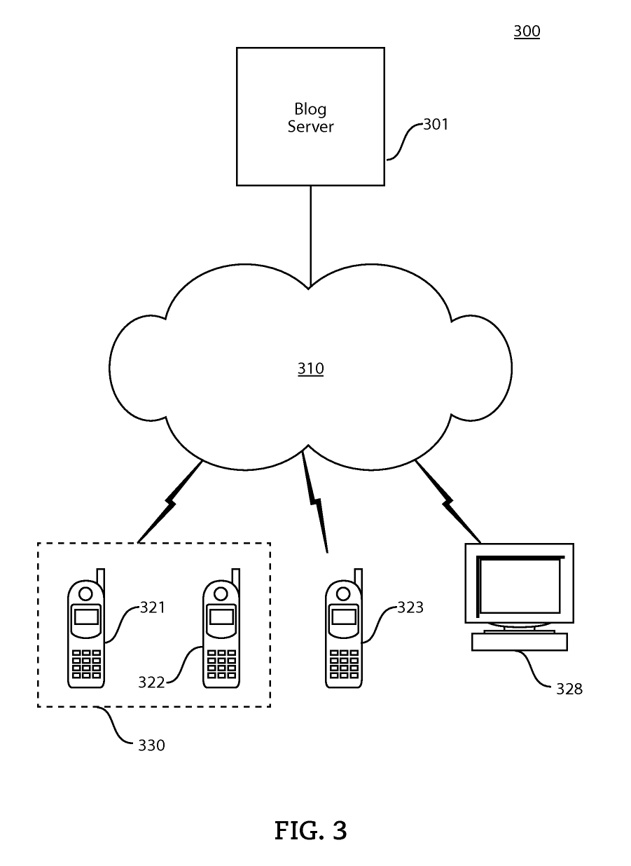

The present invention may provide a server 301 which may provide a platform for a social networking among a plurality of users. Such a system may have an embodiment as illustrated in FIG. 3, which may include system 300. System 300 may include a blog server 301 connected to the internet 310 which may have further connected thereto multiple devices. Although any device may be directly connected to the blog server 301, it is more likely that each device is connected wirelessly or through a hard wire connection to some form of the internet 310. In an embodiment of the present invention, multiple users using various devices may communicate with the blog server 301. For example, two users having mobile device 321 and mobile device 322 may be related in some way, such as, for example, by being previous connects of one another and/or by being resident in the same location. As with the user of device 323, the user of device 321 may communicate with blog server 301 to post content. Such content may include text, images, or other visual content capable of being rendered on a mobile or other electronic device.

As would be appreciated by one skilled in the art, a user of mobile device 323 may post content to blog server 301 in a linear fashion and may post in response to other users also posting to blog server 301. In the case of two users unified by a common characteristic 330, each user may literally post to blog server 301 and/or may interact between each other only later posting to blog server 301 a plurality of conversational threads and content occurring within common thread 330. In this way, two or more users may interact without posting or otherwise having contact with blog server 101 and may therefore only post to blog server 301 content or blog conversations which the users authorize.

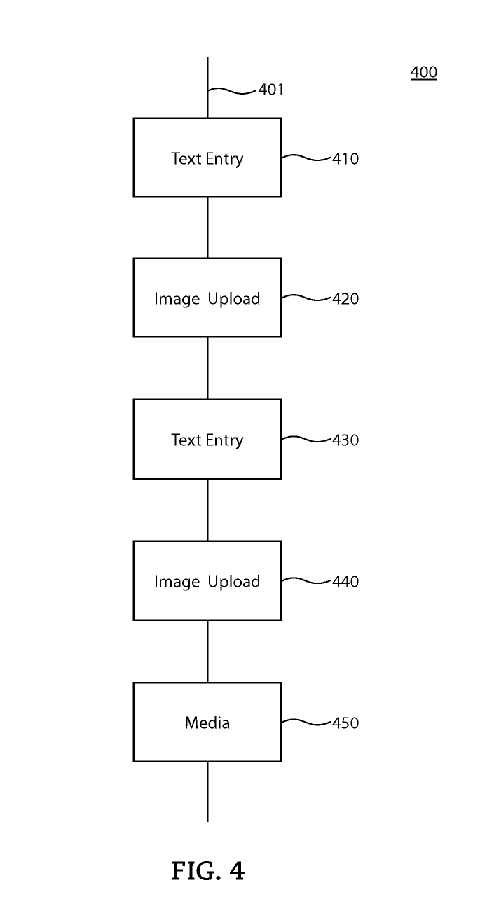

As illustrated in FIG. 4, a user of the present invention may upload various entries to a blog server which may include text, images and other media. Through connection 401, the user may enter a text entry 410 followed by an image 420 for example and may repeat the exercise with or without having connection 401 in contact with the blog server. Further, and in the embodiment of the present invention, a media file 450 may uploaded to the blog server. Such media may include not only images, but multi-frame content such as animations and/or movies, for example. Although text and other visual content may be individually uploaded to the blog server, such content may be joined together to form a unified blog posting.

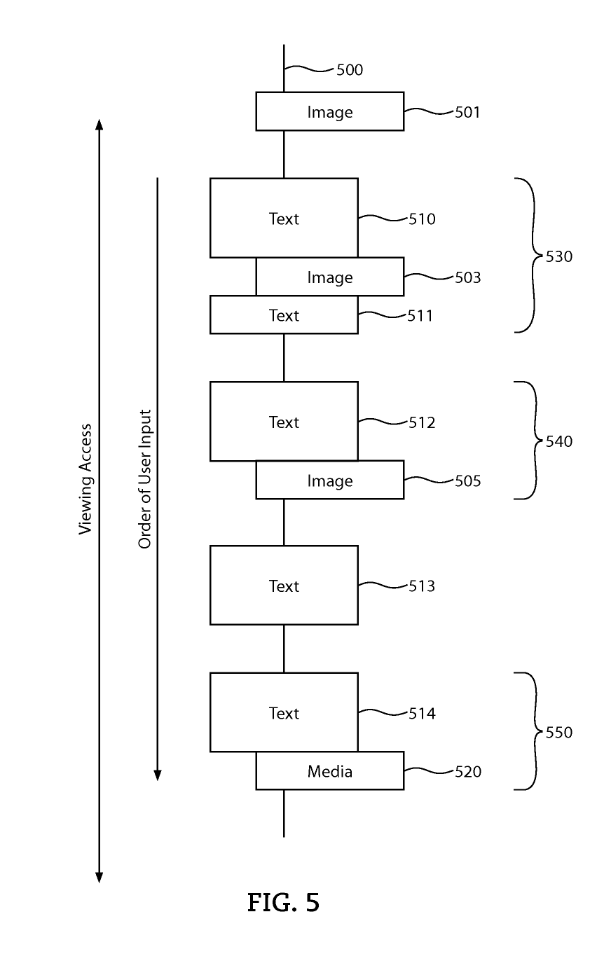

As illustrated in FIG. 5, the present invention may allow for text and other content to be joined or attributed together to form a unified blog posting. For example, feed 500 may be provided by a plurality of users who may be posting a variety of content which may include individual images 501, text and image combinations including text 510, image 503 and text 511 for example, and plain text entries 513. The text and image combination 530 may include, for example, an image associated or related to the text being entered for inclusion in the blog accessible on blog server 301. Although various user GUIs will be discussed further herein, a user may associate text with an image and/or images with text either by uploading them simultaneously to the blog server 301 and/or designating them as related through functionality provided by a GUI. By way of example, a user may upload a photograph of their dog and may associate text with the picture describing their feelings of their pet. The user may simultaneously send the picture and the text to blog server 301 and have posted thereon the picture along with the text in close association such that a reader of the blog would identify the text as being associated with the picture.

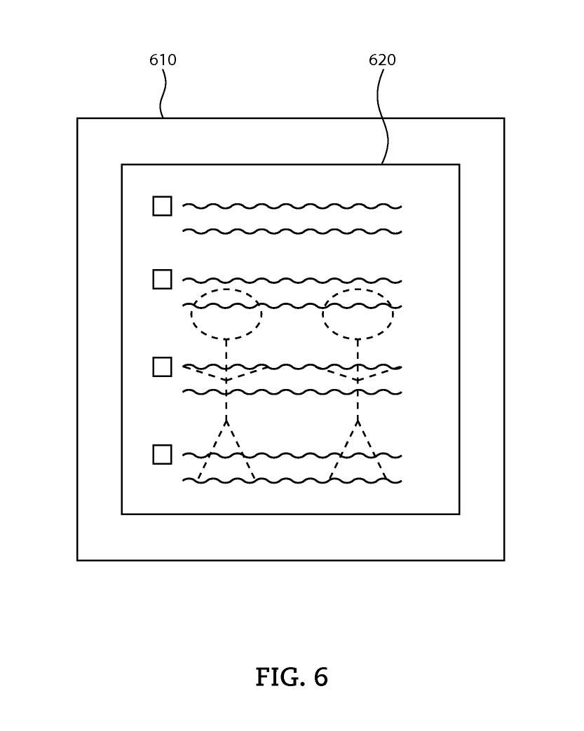

In an embodiment of the present invention, the picture of the dog would, in the background of the blog, with the text associate with the picture superimposed over the picture. Preferably, the picture of the dog would be semi-transparent and/or partially de-pixelated to allow for the clear presentation of text over the picture. As illustrated in FIG. 6, a device 610 may include a display of the blog 620 for which content has been posted. As illustrated here, a picture of two people may have been uploaded to the blog and may be presented as a background over which multiple blog entries related to that picture have been uploaded to the blog. Multiple users may comment and/or enter information over the same picture allowing for any number of entries to be associated with a single image upload.

In the case where uploaded text and comments from users exceed the viewable space provided by device 610, for example, the user may scroll through the text entries while the image related thereto remains substantially within the viewable portion 620. Such functionality may allow for multiple users to comment on a single uploaded piece of content while allowing for review of those comments by a user without losing site of the uploaded image. This may be accomplished by providing a scrolling function of the text over the uploaded image within the viewable portion 620.

Referring again to FIG. 5, the image and text combinations of 540, for example, may be preceded by plain text entry 513 which may then be preceded by, for example, a text and media combination 550. As illustrated, text 513 may not be associated with the text image combination 540 nor with the text media combination 550. Thus, when viewing the entries on the blog, a user viewing text 513 may not see the image 505 or media 520. For example, if image 505 represents a picture of a person playing a slot machine having associated therewith text 512, the viewing of text 513 by the user may force image 505 out of view. In this way, the reading of text 513 would not be confusingly associated with image 505. Although text 513 may not be present in a viewable area on a device with image 505, text 513 may adjoin at least a portion of text 512 to provide for a continuous visual stream of text within the blog. The point at which image 505 no longer appears in the viewable area relevant to text 513 may be sent by the program administration and/or locally by the user. By way of example, the user may not wish image 505 to disappear from the viewable area until all of text entry 513 is available within the viewable area. As would be appreciated by those skilled in the art, any artificial boundary may be set up in the viewable area of the blog to trigger the removal of an unrelated piece of content.

Similarly, scrolling forward in the order of user input may introduce text and media combination 550 which may have already been entered into the blog by at least one user. Media content 520 may include an image and/or may include a movie file which may be of any duration and may, preferably, be of a length suitable for mobile viewing.

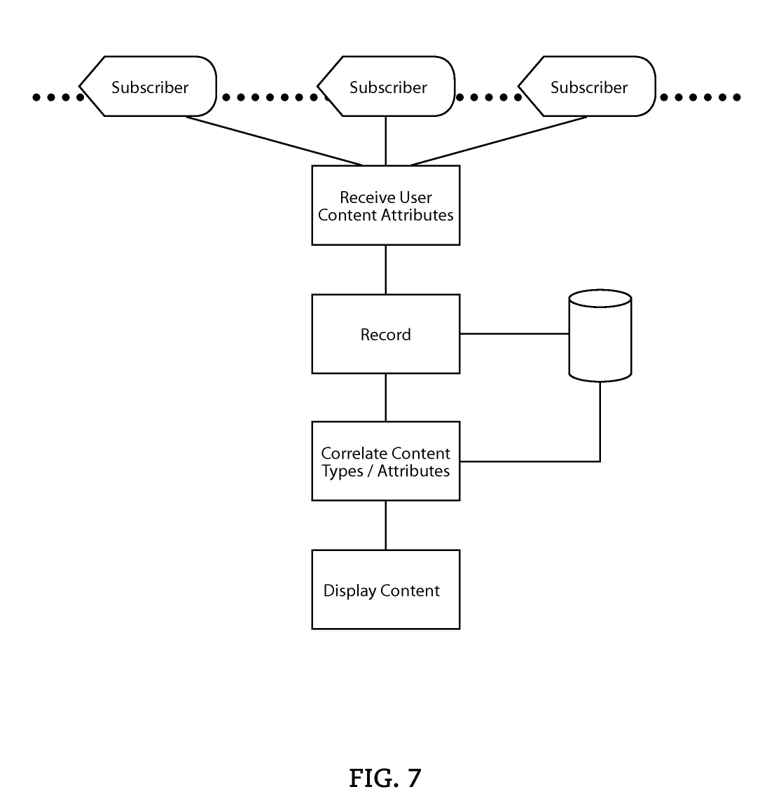

In an embodiment of the present invention, a user of the present invention may be characterized as a subscriber and may be provided access to the at least one blog server through at least one credentialed gateway and may, for example, be a user having a defined username and password associated with at least a portion of the present invention. As illustrated in FIG. 7, the present invention may receive content from a subscriber and may further collect subscriber attributes which may include, for example, specific subscriber characteristics, which may include demographic and location information, and content attributes, which may include, for example, time stamp information, location information, file type and size, and other known measurables. Such information may be retained in at least one database and may be temporally and/or maintained for a period of time.

A rules engine associated with the present invention may correlate the information based on attributes selected by the subscriber and/or administrator of the present invention. For example, text and images may be correlated together if, for example, the time stamp related to the receipt of each corresponds to a certain time frame, such as, for example, over a 10 minute period. Similarly, the content could be aggregated by keyword association. For example, an uploaded video may include the keyword “Betty” among its meta-data and may have associated therewith text entries including the term “Betty.” In this way, the received content may not be strictly temporally associated, allowing for later received content to be associated with recorded content at a time which may be outside the temporal window described above. The flexibility may allow for a more dynamic blogging experience, for example, by allowing users to continue to add to and/or update received content.

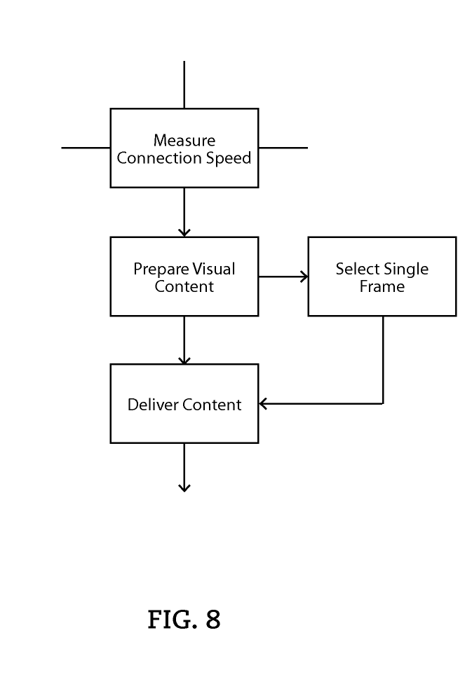

The receiving and/or sending of content may be assisted by measuring the speed at which at least one participant connection speed and illustrated in FIG. 8. Connection speed may be relatively constant and/or variable and may be suitable for the download and/or uploading of information at speeds such that, for example, the viewed content appears in real-time to the receiving user. If the connection speed is less than optimal and, for example, causes some delay in the download and/or uploading of information, the information may be sized down by, for example, depixilation and/or by selecting a single frame of a video to be at least temporarily presented, and other techniques known to those skilled in the art.

Those of skill in the art will appreciate that the herein described systems and methods may be subject to various modifications and alternative constructions. There is no intention to limit the scope of the invention to the specific constructions described herein. Rather, the herein described systems and methods are intended to cover all modifications, alternative constructions, and equivalents falling within the scope and spirit of the invention and its equivalents.

What is claimed is:

1. A computer-implemented platform for creating a social network interface, comprising:
a non-transitory computer readable storage medium having encoded thereon non-transitory computer executable instructions which, when executed by at least one processor:
provide, on at least one computing network, a graphical user interface (GUI) for the computer-implemented platform that:
provides access to a plurality of content comprising a plurality of content types;
allows for selection of at least first ones of the content from the plurality of content for association with at least second ones of the content from the plurality of content;
provides at least two of a time, type and location stamp in association with the plurality of content;
provides at least one association between the at least first ones of the content and the at least second ones of the content in accordance with at least one rule; and
provides display of the at least first ones of the content contemporaneously with at least second ones of the content from the plurality of content;
wherein the at least first ones of the content and the at least second ones of the content are of a different content type.

2. The computer-implemented platform of claim 1, wherein the at least first ones of the content is overlayed over the at least second ones of the content from the plurality of content.

3. The computer-implemented platform of claim 1, wherein the content type is selected from the group consisting of text, at least one image, at least one video, and mixtures thereof.

4. The computer-implemented platform of claim 1, wherein the association is based on the at least two of a time, type and location stamp.
